(19) United States
(12) Patent Application Publication
(10) Pub. No.: US 2013/0146726 A1
(43) Pub. Date: Jun. 13, 2013

(54) Smart-Phone & Personal Music Player Holder with Adjustable Mounting System

(71) Applicants: Mark Jeffrey Bobrow, Perry Hall, MD (US); Brian Shane Bobrow, Perry Hall, MD (US)

(72) Inventors: Mark Jeffrey Bobrow, Perry Hall, MD (US); Brian Shane Bobrow, Perry Hall, MD (US)

(21) Appl. No.: 13/677,169

(22) Filed: Nov. 14, 2012

Related U.S. Application Data
(60) Provisional application No. 61/629,162, filed on Nov. 14, 2011.

(51) Int. Cl. F16M 13/02

(52) U.S. Cl. CPC F16M 13/02
USPC 248/230.1

(57) ABSTRACT

The present invention comprises an apparatus for holding and securing a cellular phone, personal music player or other similar device (“mobile device”) to another device or item. In particular, the present invention relates to an apparatus for holding and securing a mobile device or other similar device to rigid rod-like structure such as a mode of transportation having some form of handle-bars, i.e. motorcycles, bicycles, ATV's, snowmobiles, boats, lawnmowers, and other modes of transportation. The base is open on the front and the bottom to allow access to buttons or a touch screen and accessory cables.

### CROSS-REFERENCE TO RELATED APPLICATIONS

The present application derives priority from Provisional Patent Application No. 61/629,162, filed on Nov. 14, 2011 by Mark Jeffrey Bobrow and Brian Shane Bobrow for Smart-Phone and Personal Music Player Holder with Adjustable Mounting System.

### BACKGROUND OF THE INVENTION

1. Field of the invention

The present invention relates generally to an apparatus for holding and securing a cellular phone, personal music player or other similar device (“mobile device”) to another device or item. In particular, the present invention relates to an apparatus for holding and securing a mobile device or other similar device to a rigid rod-like structure, such as a mode of transportation having some form of handle-bars, i.e. motorcycles, bicycles, ATV's, snowmobiles, boats, lawnmowers, and other modes of transportation.

2. Description of the Background

Mobile devices have gained in popularity and are continually advancing in their capabilities including GPS capabilities. Increased capabilities have led to many individuals becoming dependent on these devices and requiring them to be accessible at all times. This dependence creates the need for an apparatus to safely secure the mobile device while traveling. This need is especially present in certain modes that do not have readily accessible locations that allow the operator to access the mobile device while traveling. The need exists for a mobile device holder for securing a mobile deviceto vehicles and/or devices possessing handlebars, such as such as motorcycles, bicycles, ATVs, snowmobiles, boats, lawnmowers and the like. These vehicles are typically not equipped with integrated smart cell phone and personal music player holders, and therefore must be retrofitted with after-market smart cell phone and personal music player holders.

Apparatus for securing or attaching smart cell phone and personal music to handlebars do exist in the prior art. The prior art examples generally include clamp structures for mounting to the handlebars of a motorcycle or the like. While these devices may serve a purpose of securing the device to the handlebars, they lack an adjustable mounting system that allows for the mobile device holder to be retrofitted and properly positioned for a wide variety of handlebar arrangements and positions. Conventional mobile device holders also are not constructed in a manner that is sufficiently durable, functional, versatile, and attractive to satisfy consumers in the marketplace.

While the existing devices may fulfill their objectives and purposes, they do not embody the functional and design features and advantages of this new apparatus for holding and securing a smart cellular phone, personal music player or other similar device to another device or item such as handlebars.

### SUMMARY OF THE INVENTION

A first object of the present invention is to provide an apparatus for holding and securing a mobile device that can be attached to the handlebars of a vehicle, such as such as a motorcycle, bicycle, ATV, snowmobile, boat, lawnmower or the like.

A second object of the present invention is to provide an apparatus for securing and holding a mobile device that attaches to handlebars and that is fully adjustable and able to accommodate a wide variety of handlebar shapes and configurations as well as a variety of user preferences.

A further object of the present invention is to provide an apparatus for securing and holding a mobile device that is not only functional and attractive, but is also durable, economical to manufacture and particularly well suited for use in securing a mobile device to handlebars.

According to the present invention, the apparatus for securing a mobile device to handlebars is comprised of two major components; a rectangular shaped base and a clamp assembly. These two components are secured together utilizing a threaded fastener. The base is rectangular in shape with an open front to allow access to the touch-sensitive screens available on many mobile devices. Additionally, the bottom side of the base is open in the center to permit access to the mobile device's charging or similar ports. The back side of the base possesses an elongated opening extending from top to bottom through which the threaded fastener passes to secure the base to the clamp assembly. The elongated opening allows for the clamp assembly to be secured at varying heights along the back side of the base. To connect the clamp assembly to the base, the threaded fastener extends through the elongated opening and into a corresponding opening in the clamp assembly. The threaded fastener is arranged to slide along the elongated opening to permit vertical adjustment of the base relative to the clamp assembly. The threaded fastener also allows the base to be adjusted on a pivot (rotated) relative to the clamp assembly permitting the user to adapt the apparatus to the angle of his/her choice.

In the preferred embodiment of this invention the base has inner dimensions sufficient to hold and secure a typical mobile device. These dimensions are generally a width between one (1) inch and four (4) inches and a height between two (2) inches and eight (8) inches. The base and the clamp assembly are constructed of a hard polycarbonate plastic or other suitably rigid and durable material. The thickness of the base ranges from 0.01 inches to 0.5 inches. In the preferred embodiment a cushioning material (i.e. foam padding or other material suitable for cushioning) may be affixed to the inner aspects of the base to cushion and protect the mobile device contained therein. The cushioning also provides traction to prevent the mobile device from shifting within the base and/or from falling out of the base.

In some embodiments, a variety of other materials are utilized to achieve a similar result or appearance. Materials such as plastics, fiberglass, carbon fiber, synthetic fiber, steel, copper or any other suitable metals, alloys, or plastics could be used in lieu of polycarbonate plastic to create the apparatus depicted and/or described herein. Other types of components may also be utilized without compromising the integrity or functionality of the present invention so long as they achieve the desired results.

### BRIEF DESCRIPTION OF THE DRAWINGS

FIG. 1 is an angled side/rear perspective view of the apparatus for holding and securing a mobile device.

FIG. 2 is the angled side/rear perspective view shown in FIG. 1 blown apart to better illustrate the components.

FIG. 3 is a front perspective view of the apparatus for holding and securing a mobile device.

FIG. 4 is a rear perspective view of the apparatus for holding and securing a mobile device.

FIG. 5 is an overhead top-down perspective view of the apparatus for holding and securing a mobile device.

FIG. 6 is a straight ahead front view of the apparatus for holding and securing a mobile device.

### DETAILED DESCRIPTION OF THE PREFERRED EMBODIMENTS

The present invention relates to an apparatus for holding and securing a mobile device to another device or item. Specifically it is an apparatus for securing a mobile device or other similar device to a rigid rod-like structure, such as a mode of transportation having some form of handle-bars.

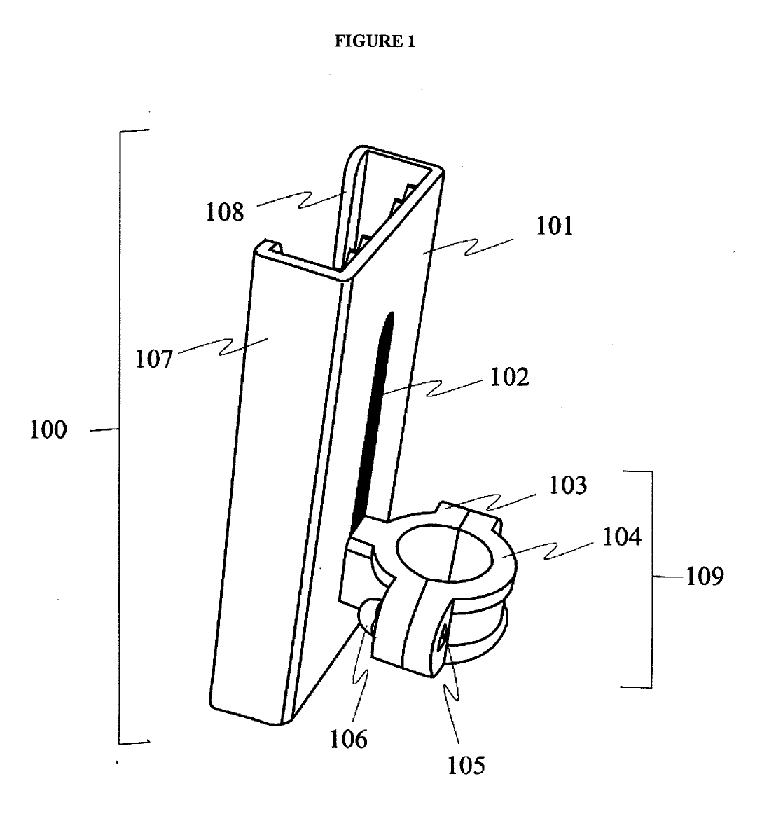

FIG. 1 illustrates an angled side/rear perspective view of the apparatus for holding and securing a mobile device with the base 100 and clamping assembly 109 engaged. As illustrated, the rear side 101 of the base 100 possesses an elongated opening 102 which extends along the majority of the length of the rear side 101 of the base 100 from top to bottom. The sides 107 of the base 100 are solid and the front side 108 is mostly open to permit the user to view the front of a mobile device when placed in the apparatus. As illustrated, the clamp assembly 109 is comprised of a front section 103 and a rear section 104. The front section 103 and the rear section 104 of the clamp assembly 109 are held together via two threaded fasteners 105 engaged with two treaded nuts 106. This configuration permits the user to attach the clamp assembly 109 to a handlebar by aligning the front section 103 and the rear section 104 on either side of the handlebar and inserting the threaded fastener 105 through both the front section 103 and the rear section 104 of the clamp assembly 109 and engaging the threaded nut 106 with the threaded fastener 105 and tightening the threaded fastener 105 to secure the clamp assembly 109 in place on the handlebar.

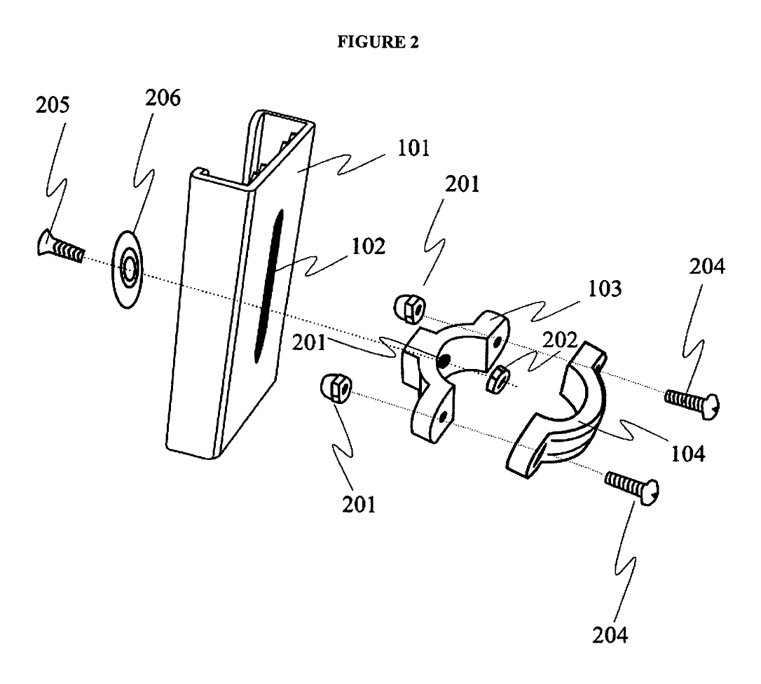

FIG. 2 illustrates the angled side/rear perspective view shown in FIG. 1 wherein the assembly is blown apart to better illustrate the components. As illustrated the base possess an elongated opening 102 extending along its length from top to bottom. FIG. 2 clearly illustrates the separate components of the clamp assembly 109. As shown, the front section 103 of the clamp assembly 109 possesses three openings which go from the front through to the rear of the front section 103. The center opening 201 is narrower at the front end of the front section 103 than it is at the rear end of the front section 103. This difference in diameter of the center opening 201 permits the nut 202 that secures the threaded fastener 205 to set recessed in the front section 103 of the clamp assembly 109. The remaining two openings in the front section 103 of the clamp assembly 109, along with the two openings through the rear section 104 of the clamp assembly 109 are also recessed in the same manner to permit a secure locking fit between the threaded fasteners 204 and the nuts 201. This figure also illustrates the threaded fastener 205 and the washer 206 which are engaged to attach the base 100 to the clamp assembly 109. Importantly, the washer 206 is of a diameter that is wider than the width of the elongated opening 102. The use of the threaded fastener 205 and the washer 206 permits the user to adjust height of the clamp assembly 109 in relation to the base 100 by varying the point along the elongated opening 102 in the rear side 101 of the base 100 where the threaded fastener 205 is engaged with the nut 202 and tightened.

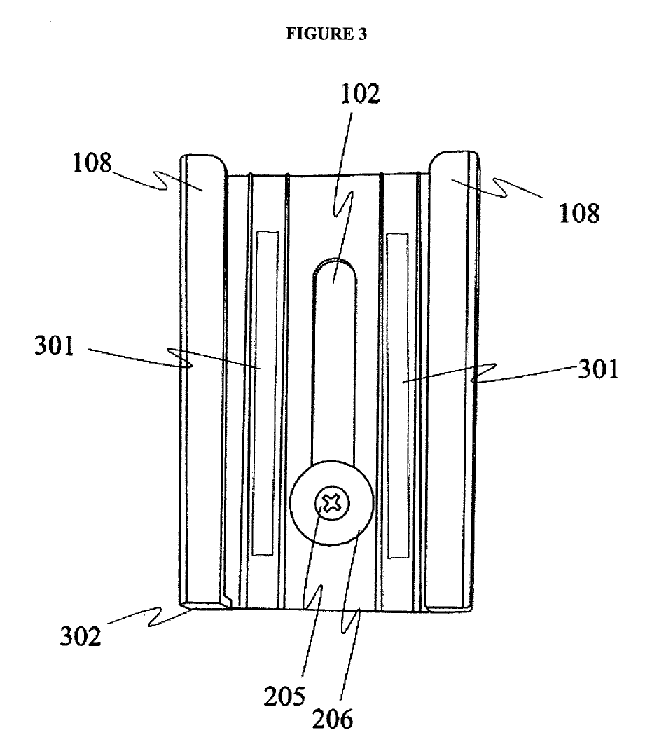

FIG. 3 illustrates a front perspective view of the apparatus for holding and securing a mobile device. This figure illustrates the front side 108 of the base 100. As shown the threaded fastener 205 and the washer 206 which secure the clamp assembly 109 to the base 100 are engaged at the lowest vertical position of the elongated opening 102 in the rear side 101 of the base 100. The figure also illustrates that the bottom side 302 of the base 100 is closed at either end but remains open in the middle portion to permit the user to engage the bottom end of a mobile device where the access ports are typically located. Also illustrated are the cushions 301 which are shown running vertically along the inner rear side 101 of the base 100. These cushions 301 serve to both protect and secure the mobile device within the base 100.

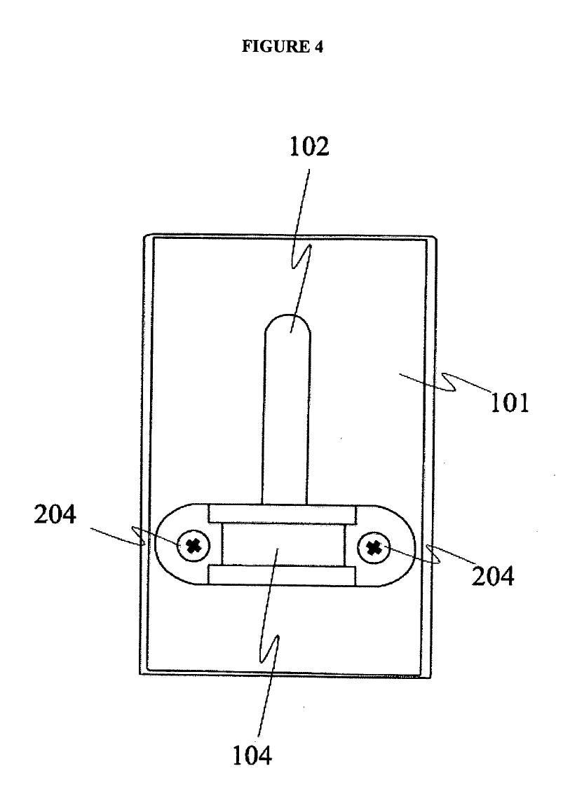

FIG. 4 illustrates a rear perspective view of the apparatus for holding and securing a mobile device. As illustrated the clamp assembly 109 is again engaged with the base 100 at the lowest vertical position along the elongated opening 102 in the rear side 101 of the base 100. Also shown are the threaded fasteners 204 that are utilized to connect and secure the front section 103 and the rear section 104 of the clamp assembly 109.

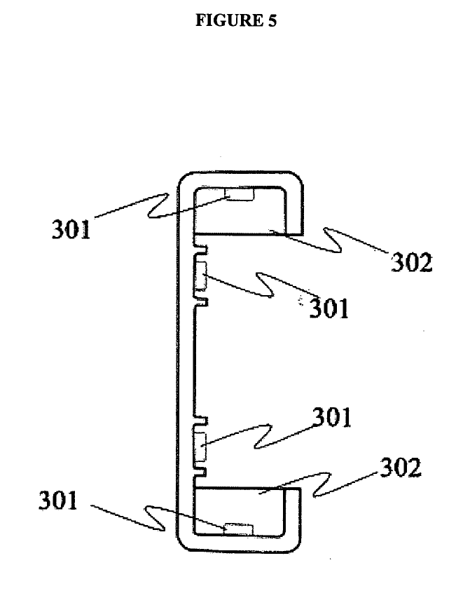

FIG. 5 illustrates an overhead, top-down perspective view of the apparatus for holding and securing a mobile device. As illustrated, the top end of the base 100 is completely open to permit a mobile device to be inserted into the base 100. The figure also illustrates that the bottom end 302 of the base 100 is closed at the ends and open in the center to permit the use of accessories with a mobile device that is inserted into the base 100. Clearly visible in this illustration are a series of cushions 301 which are placed vertically along the rear side 101 of the base 100 and also along the end sides 107 of the base. The positioning of the cushions 301 as illustrated is not the only positioning possible for the cushions 301, other positions and series of cushions 301 are possible and within the scope of this invention.

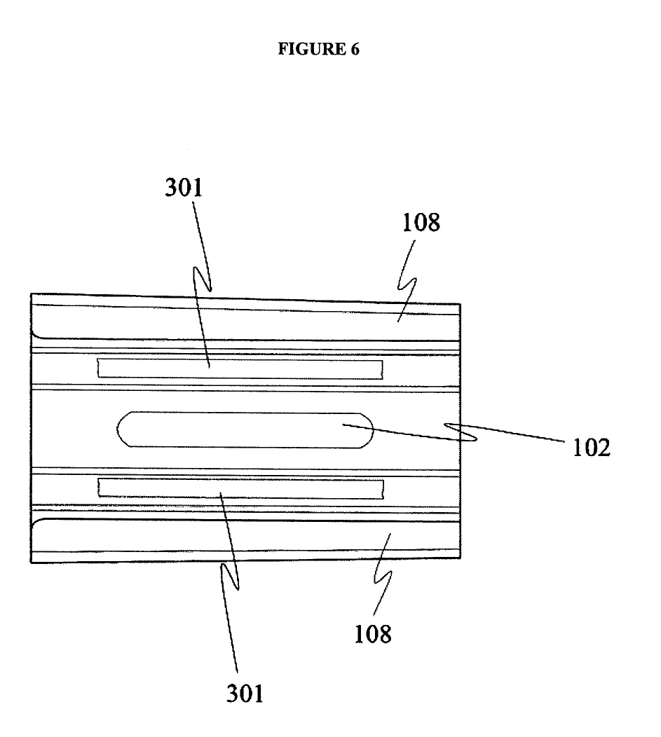

FIG. 6 illustrates a straight ahead view of the base 100 of the apparatus for holding and securing a mobile device. Again, this figure illustrates that the front side 108 of the base 100 is open in the center and closed at the ends to secure a mobile device within the base 100. Also shown in this figure is the elongated opening 102 in the rear side 101 of the base 100 and one possible configuration of the cushions 301 along the rear side 101 of the base 100.

A number of embodiments have been described. Nevertheless, it will be understood that various modifications may be made without departing from the spirit of the scope of the invention. For example, the physical shapes, dimensions and materials of the various system components (e.g. polycarbonate plastic, threaded fasteners, nuts, etc.) can vary considerably. For example, in some implementations the base 100 and clamp assembly 109 may be comprised of a rigid metal, or the cushions 301 may be placed in a different configuration.

Other implementations are within the scope of the claims.

What is claimed is:

1. An apparatus for holding and securing a mobile device, comprising:
a body possessing a generally rectangular shape with an open top, a significantly open bottom, a significantly open front, substantially closed sides, and a substantially closed rear side that possesses an elongated vertical opening;
a clamp assembly having front and rear sections which are assembled together and adapted to encircle and clamp to a rigid bar on which the apparatus is to be mounted; and
an adjustable mounting system connecting the mobile device holding base to the clamp assembly, said adjustable mounting system comprising the elongated opening in the rear side of the base that extends vertically along the base, and a threaded fastener extending through a washer and through the elongated vertical opening and into a corresponding opening in the first section of the clamp assembly, said threaded fastener being operable to allow the mobile device holding base to be pivotally and vertically adjusted relative to the clamp assembly and to secure the mobile device holding base to the clamp assembly in a desired and fixed position.

2. The apparatus for holding and securing a mobile device according to claim 1, wherein the threaded fastener comprises a threaded bolt and a threaded nut.

3. The apparatus for holding and securing a mobile device according to claim 2, wherein the threaded bolt has a tapered head, and the washer is a dimpled washer having a countersunk recess on one side into which the tapered head is received, said dimpled washer being slideable along the elongated vertical opening in the rear side of the base.

4. The apparatus for holding and securing a mobile device according to claim 3, wherein the elongated vertical opening in the rear side of the base has tapered inner surfaces that converge toward one another in a direction toward the clamp assembly, and said dimpled washer has a tapered surface which engages the tapered inner surfaces of the elongated vertical opening in the rear side of the base.

5. The apparatus for holding and securing a mobile device according to claim 1, wherein said front and rear sections of said clamp assembly each comprises a semicylindrical inner surface and a pair of mounting flanges with mounting holes formed in each of the mounting flanges, said front and rear sections of said clamp assembly being assembled together with the mounting holes of the front section aligned with the mounting holes of the second section and a pair of threaded fasteners extended through the respective mounting holes.

6. The apparatus for holding and securing a mobile device according to claim 5, wherein said pair of threaded fasteners comprises a pair of threaded bolts and a pair of threaded nuts.

7. The apparatus for holding and securing a mobile device according to claim 1, wherein said corresponding opening in the front section of the clamp assembly comprises a bore through the front section of the clamp assembly, and a recess in an inner surface of the front section of the clamp assembly which accommodates a threaded nut of the threaded fastener.

8. The apparatus for holding and securing a mobile device according to claim 1, wherein a cushioning material is applied to the inner surface of the sides and the inner surface of the rear side of the base.

9. The apparatus for holding and securing a mobile device according to claim 8, wherein said cushioning material is foam padding.

10. The apparatus for holding and securing a mobile device according to claim 1, wherein said base and said clamp assembly are made of injection molded plastic.

11. The apparatus for holding and securing a mobile device according to claim 1, wherein said base and said clamp assembly are made of polycarbonate plastic.
